(19) United States
(12) Patent Application Publication
(10) Pub. No.: US 2003/0097582 A1
(43) Pub. Date: May 22, 2003

(54) Method and system for reducing personal security device latency

(76) Inventors: Yves Audebert, Los Gatos, CA (US); Olivier Clemont, Fremont, CA (US)

Correspondence Address: STEVENS, DAVIS, MILLER & MOSHER, L.L.P., Suite 850, 1615 L Street, N.W., Washington, DC, 20036, US

(21) Appl. No.: 09/988,301

(22) Filed: Nov. 19, 2001

(51) Int. Cl. H04L 9/00

(52) U.S. Cl. 713/200; 713/189

(57) ABSTRACT

This invention describes a system and method for reducing communications throughput latency caused by the low-level communications protocol and serial communications interface associated with the use of personal security devices. To improve the data throughput, a cache is created under the exclusive ownership of an API level program called a cache server. The cache server maintains access rights associated with the data transferred from the PSD into cache memory. Requests made by programs for cached PSD data are first verified for access rights and serviced by the cache server. Cryptographic techniques may be employed to prevent unauthorized monitoring of the contents of the cache.

### FIELD OF INVENTION

The present invention relates in general to a data processing method and system for reducing latency in accessing information contained within a Personal Security Device (PSD) and specifically to the inclusion of a secure caching program.

### BACKGROUND OF INVENTION

The current art involving the management of information and data contained in a personal security devices (PSD), for example, smart cards, subscriber identity modules (SIM), wireless identification modules (WIM), biometric devices, or combinations thereof, requires discrete low-level commands known in that art as application protocol data units (APDUs) to be sent to a PSD through a relatively low speed serial interface.

In many cases multiple requests are made through the PSD communications interface to access all or portions of the same information previously obtained. This results in unnecessary time delays, which could be significantly alleviated if the requested information were retained in some sort of cache. However, caching information normally stored within a PSD defeats, to some extent, the main purpose in using a PSD. Therefore, some trade-off is necessary to optimize performance without unnecessarily compromising the security mechanisms employed within a PSD.

For example, U.S. Pat. Nos. 6,273,335 and 6,179,205 by Sloan describe inter alia methods for the caching of password and user IDs; U.S. Pat. No. 6,158,007 by Moreh and U.S. Pat. No. 6,105,027 by Schneider describe method of caching of authentication information; U.S. Pat. No. 6,092,202 by Veil describes a method of caching digital certificates; U.S. Pat. No. 5,941,947 by Brown describes a method of caching access rights. All of these patented methods mainly rely on security mechanisms incorporated into the operating systems of the computers in which the caches are established, which are potentially vulnerable to a sophisticated attack utilizing a Trojan Horse type virus designed to scan and record memory contents.

Another method of accelerating smart card responsiveness is described in U.S. Pat. No. 6,018,717 by Lee, which discloses a dual level authorization method to improve smart card responsiveness. While this method retains the security mechanisms incorporated into a smart card, the method reverts to a traditional smart card transaction when a particular transaction exceeds the first level authorization requirements.

### BRIEF SUMMARY OF THE INVENTION

The present invention is directed to a method and system, which minimizes potential latency problems associated with the use of PSDs. To practice this invention, a specialized API level program is incorporated into the PSD control software, hereinafter called a cache server, of a client. The cache server is provided with exclusive access rights to an associated PSD by locking the PSD interface I/O port of the client to the cache server following successful validation of the end user's personal identification number (PIN) or any equivalent technique (e.g. biometrics), which may be used to authenticate the PSD to the end user. Once the cache server has access to the PSD, the cache server securely transfers the available contents of the card to a secure cache established in volatile memory of the client. The cache server may be programmed in any high language such as C, C++ or Java.

Requests to access the PSD are routed through the cache server, which verifies the access rights of the requesting program. The access rights may be verified using a session key, dedicated IP address, token or other pre-established means. The access rights also determine what portions of the cached data is available to the requesting program. Upon successful verification of the access rights by the cache server, the requested data is released to the calling program.

In the preferred embodiment of the invention, the cached data is converted into a higher-level format for direct use by a verified requesting program. The secure memory cache may be cryptographically protected using a session key to prevent sophisticated memory monitoring programs from compromising the stored data.

The secure memory cache is flushed upon logout of the end user and/or attempted login of another user, rebooting of the computer, when the computer is powered down or upon encountering an error situation.

### BRIEF DESCRIPTION OF THE DRAWINGS

A more complete understanding of the present invention may be accomplished by referring to the following Detailed Description and Claims, when viewed in conjunction with the following drawings:

FIG. 1A—is a system block diagram depicting an arrangement of hardware components used in implementing the present invention,

FIG. 1B—is a system block diagram depicting a version of the present invention where a secure cache is established under the control of the cache server,

FIG. 2—is a system block diagram depicting a version of the present invention where the cache server verifies the access level of a requesting program,

FIG. 3—is a system block diagram depicting a version of the present invention where the cache server releases the requested data,

FIG. 4—is a flow chart depicting the overall operation of the cache server.

### DETAILED DESCRIPTION OF THE INVENTION

This invention provides a method and system for decreasing the latency inherit in data transfers from a PSD. In this invention, data stored inside a PSD is securely transferred to volatile memory under the exclusive control of a cache server program. The cache server subsequently services requests for data that otherwise would be directed and supplied by an associated PSD. The cache server requires verification of the requesting program access rights before supplying the requested information. Data access rights are preserved by the cache server, supplying only data authorized by the access level of the requesting program.

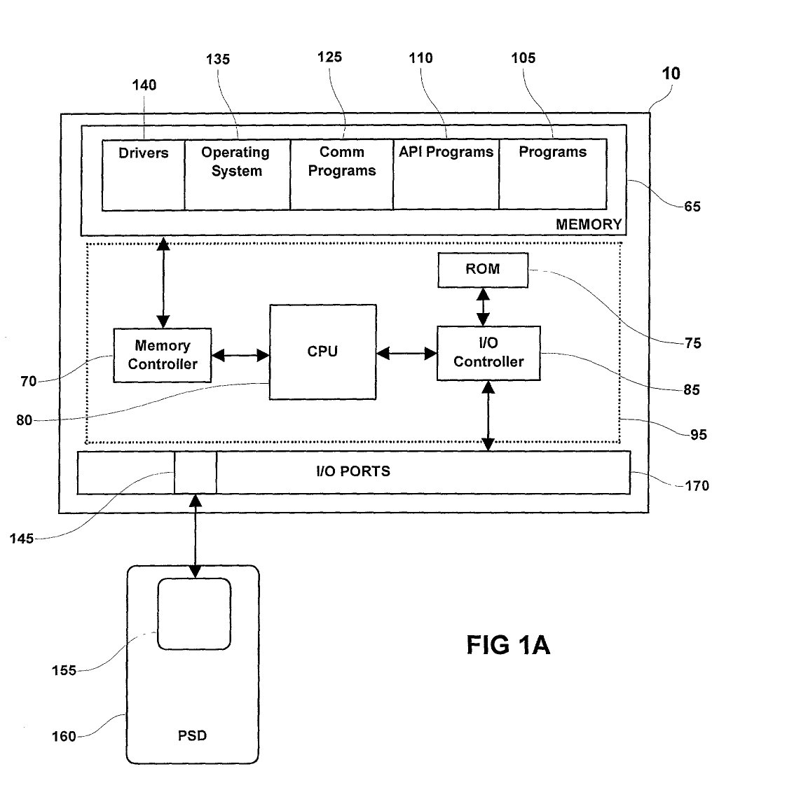

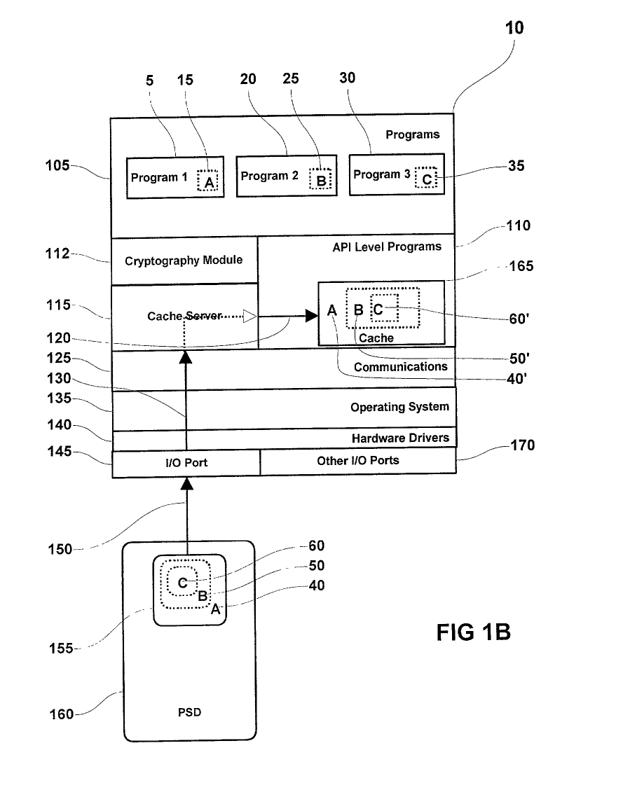

FIG. 1A provides an overview of a typical hardware configuration used to implement the present invention. A local client 10 is shown including:

Data storage such as volatile and non-volatile system memory 65 of sufficient capacity to store necessary hardware drivers 140, operating system or runtime environment 135, communications programs 125, API level programs 110 and user applications 105;

A data processing system 95, including a central processing unit (CPU) 80 for executing programmatic instructions and maintaining overall control of the client's hardware and software resources, a memory controller 70 which allows the CPU 80 to store and retrieve information using system memory 65, an input/output controller (I/O controller) 85 which allows the CPU 80 to control and communicate with devices connected to I/O ports 170, read only memory (ROM) 75 containing specific instructions for configuring the CPU 80 to test and utilize available hardware and software resources.

A set of input/output ports (I/O ports) 170 for control and communication with attached peripheral devices. In this figure, the PSD 160 is assigned a unique I/O port 145 which allows the client 10 to communicate and transfer data contained within the secure domain 155 of the PSD 160.

Referring to FIG. 1B, a block diagram of a local client 10 is shown in an Open Systems Interconnection (OSI) reference model arrangement. For simplicity, certain layers are omitted and should be assumed to be present and incorporated into adjacent layers. The layers and components of interest include:

The Applications Layer 105 generally contains higher-level software applications and a user interface, such as a graphical user interface (GUI). Three programs are included for example purposes:

a first program 5, Program 1, having A level 15 data access rights,

a second program 20, Program 2, having B level 25 data access rights, and

a third program 30, Program 3, having C level 35 data access rights.

The Applications Programming Interface Layer (API) 110 is used for processing and manipulating data by either higher or lower level applications. This layer includes the cache server program 115 and its associated secure cache 165. Data stored in the secure cache is organized by access rights. Access level A 40′ is the highest level access which allows access to the entire secure cache. Access level B 50′ is lower in access level and allows access to all data except that designated exclusively to access level A 40′. Access level C 60′ is the lowest level access and is restricted to data contained at the C level 60′ only. A cryptography module 112 is included to protect information contained in the secure cache 165 and in maintaining secure communications with other computer systems.

A Communications Layer 125 contains communications programs including secure communications capabilities, which enable the Client 10 to communicate with other computer systems. Requests generated by higher-level programs to access physical devices are directed through this layer to the Operating System layer 135 for access to a designated hardware device driver.

The Operating System Layer 135 controls the allocation and usage of hardware resources such as memory, central processing unit (CPU) time, disk space, hardware I/O port assignments, and peripheral device management. Requests generated by higher-level programs to access physical devices are serviced by this layer and assigned to a designated hardware device driver contained in the Hardware Device Layer 140.

The Hardware Driver Layer 140 allows the operating system to communicate and control physical devices connected to the Client's 10 hardware I/O bus, which are connected to the Physical Device Layer 145. Requests generated by higher-level programs to access physical devices are assigned a designated hardware device driver by the Operating System Layer 135 which allows communications with the physical devices.

The Physical Device Layer 145 is the actual interface point where hardware connections are wired to the Client's interface bus (I/O bus) and assigned a hardware I/O port address by the Operating System Layer 135. In this depiction, an associated PSD 160 is physically connected and assigned an I/O port 145. Additional hardware devices may be connected at this level using any of the remaining I/O ports 170.

In this depiction, the cache server 115 has locked the I/O port 145 associated with the PSD to itself and initiated a secure data transfer 150 from the secure domain 155 of the PSD. The PSD data is shown including the organized data access levels of A 40, B 50 and C 60. This data is transferred through the locked I/O port 145 and into 130 the cache server 115. The cache server, using a pre-determined session key generated by the cryptography module 112 encrypts the data being transferred and allocates storage space in volatile memory to securely store the data in the cache 165. Allocations of the PSD I/O port 145 and memory locations allocated for the secure cache 165 remain locked to the cache server 115. Requests for data contained in the PSD are intercepted and serviced by the cache server 115.

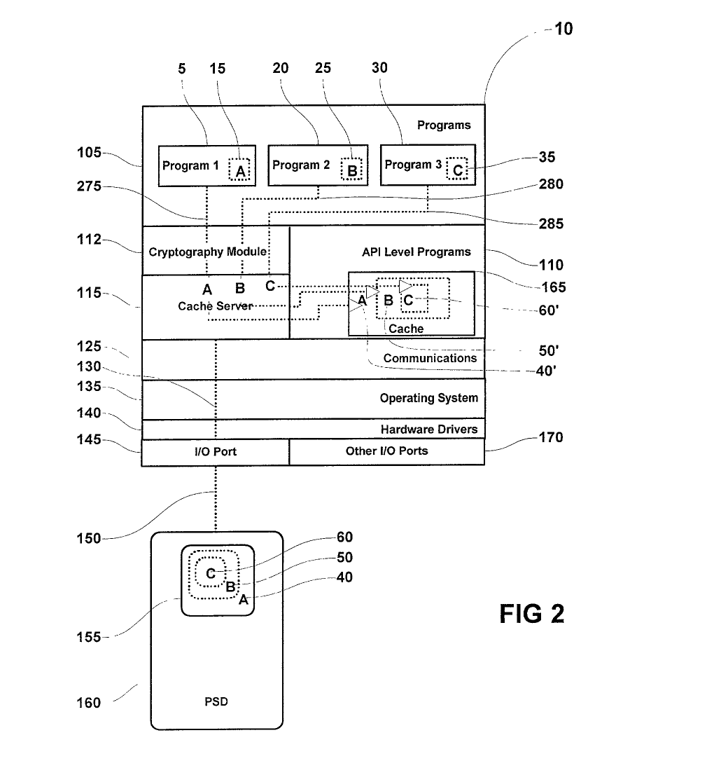

Referring to FIG. 2, the access level verification capabilities of the cache server 115 assures that a requesting program has valid access rights to the data being requested. In this illustration, three separate programs, i.e. first Program 1 5 having A level 15 data access rights, second Program 2 20 having B level 25 data access rights and third Program 3 30 having C level 35 data access rights are requesting 275, 280, 285 data contained in the secure cache 165. The program's access rights A 15, B 25 and C 35 are compared against the access rights of the data A 40′, B 50′ and C 60′.

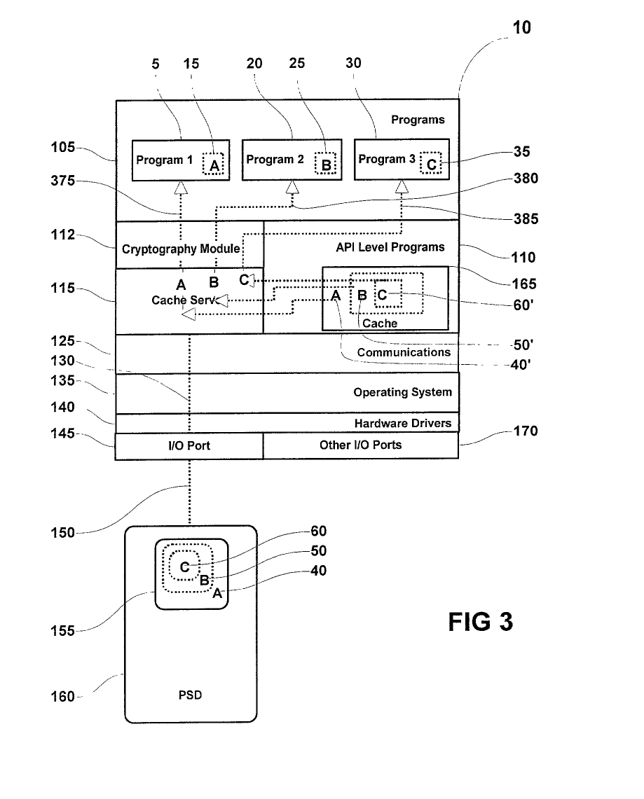

Referring to FIG. 3, if the access rights A 15, B 25 and C 35 are sufficient, the cache server 115 decrypts the requested data and provides the requested data 375, 380, 385 to each of the requesting programs Program 1 5, Program 2 20 and Program 3 30. If any of the access rights are insufficient, the request is denied.

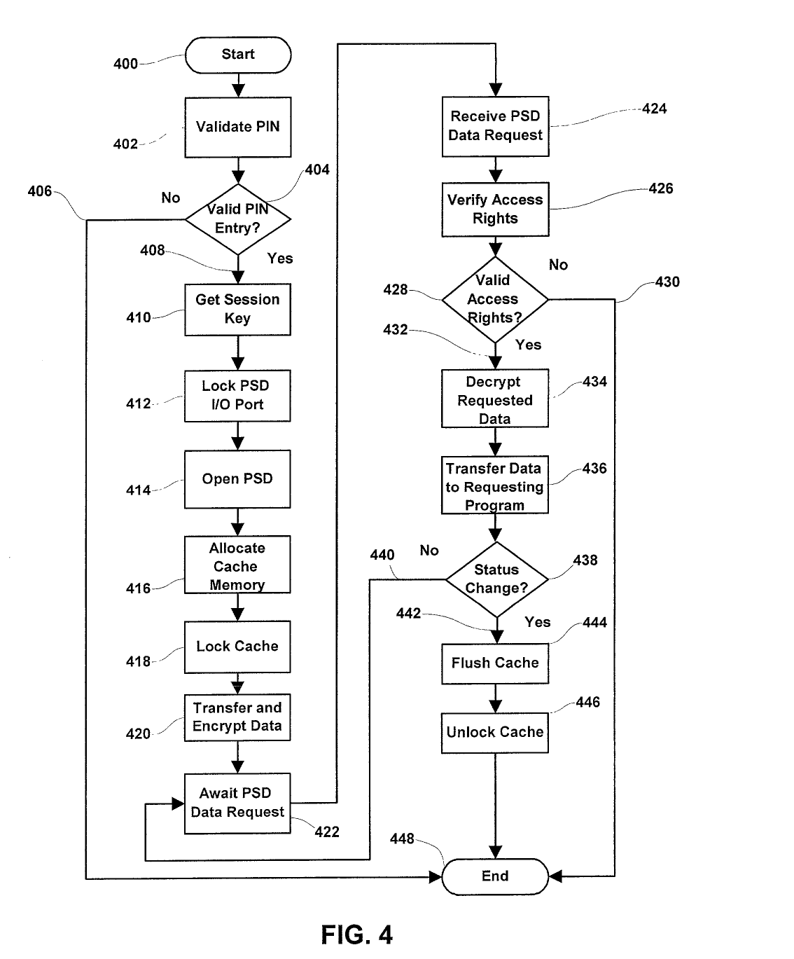

Referring to FIG. 4, the overall flow diagram of the invention is depicted. The cache server process is initiated 400 when a PSD is connected to a client which causes the entry of a personal identification number (PIN) by the end user. The PIN entry causes 402 a PIN validation routine internal to the PSD to verify the correctness of the PIN entry 404. If an incorrect PIN is entered 406 after a preset number of attempts, the process ends 448. If the correct PIN is entered 408, a session key 410 is generated and passed to the cache server. Other authentication methods including biometric and shared symmetric key comparisons are also envisioned by the inventors.

The PSD I/O port is then assigned to the cache server 412, preventing other programs from accessing the PSD. The cache server then opens the PSD 414, allocates storage space in volatile memory 416. The allocated cache memory is exclusively allocated to the cache server 418. After memory resources are exclusively allocated to the cache server, the cache server initiates secure data transfer 420 from the PSD to the secure cache 416. The session key 410 is used to encrypt the data being transferred to the secure cache 416.

The cache server is now available to service data requests and awaits an incoming data request 422. Upon receipt of an incoming request 424, the cache server verifies the requesting program's access rights 426. The validation routine 428 determines if the access rights are sufficient to allow transfer of the data from the cache to the requesting program. If insufficient access rights exist 430, the process ends 448. If sufficient access rights exist, the cache server decrypts 434 the requested data and transfers 436 the data to the requesting program.

If a status change is encountered 438 such as logout of the end user, attempted login of another user, rebooting of the computer, or upon encountering an error situation, the secure cache is flushed 444, the memory allocation released 446 from exclusive cache server use and the process ends 448. If no status change is encountered, the cache server awaits 422 for another PSD data request as before.

What is claimed:

1. A system for reducing PSD data throughput latency comprising;
a client including at least data storage means, data processing means, cryptography means, and an I/O port for functionally connecting to a PSD, wherein;
said data processing means includes means for allocating and reserving storage space in said data storage means of said client for use as a memory cache;
said data processing means further includes a cache server program for managing data stored inside said PSD, wherein said cache server program is assigned exclusive rights to said assigned I/O port and said memory cache and includes means for;
transferring at least a portion of said data stored inside said PSD to said memory cache;
retaining access rights associated with said transferred data;
receiving requests from at least one requesting program having access rights to at least a portion of said transferred data;
verifying access rights by at least one requesting program; and
transferring at least a portion of said cached data to said at least one requesting program.

2. The system according to claim 1, wherein said cache server program cryptographically protects said data transferred from said PSD to said memory cache using said cryptography means.

3. The system according to claim 2, wherein said cache server program removes said cryptographic protection from said data being transferred to said at least one requesting program.

4. The system according to claim 1, wherein said memory cached is flushed upon a status change.

5. The system according to claim 4, wherein said assigned exclusive rights to said assigned I/O port and said memory cache are released upon said status change.

6. The system according to claim 4, wherein said status change includes logout of an end user, attempted login of a second end user, rebooting of said client or upon encountering an error situation.

7. The system according to claim 1, wherein said cache server program is executed following successful end user validation by said PSD.

8. The system according to claim 1, where said memory is volatile memory.

9. A method for reducing PSD data throughput latency comprising;
functionally connecting a PSD including at least some data to a client, wherein said client includes at least data storage means, data processing means, cryptography means, and an I/O port,
executing a cache server program in said client,
allocating storage space in said data storage means for use in caching said at least some data in a memory cache,
accessing said PSD through said I/O port by said cache server program,
transferring said at least some data from said PSD to said memory cache,
retaining access rights to said at least some data by said cache server program,
receiving requests from at least one requesting program having access rights to at least a portion of said transferred data;
verifying said access rights by said at least one requesting program; and
transferring at least a portion of said cached data to said at least one requesting program.

10. The method according to claim 9 further including the steps of:
assigning exclusive rights to said I/O port and said memory cache to said cache server program,
cryptographically protecting said data transferred from said PSD to said memory cache,
removing said cryptographic protection from said data transferred to said at least one requesting program.

11. The method according to claim 9 or 10 wherein said cache server program is executed following successful PIN validation by said PSD.

12. The method according to claim 10 wherein memory cache is flushed upon a status change.

13. The method according to claim 12 wherein said assigned exclusive rights to said I/O port and said memory cache are released upon said status change.

14. The method according to claim 12 or 13 wherein said status change includes logout of an end user, attempted login of a second end user, rebooting of said client or upon encountering an error situation.
